(19) United States
(12) Patent Application Publication
(10) Pub. No.: US 2022/0347715 A1
(43) Pub. Date: Nov. 3, 2022

(54) SYSTEMS AND METHODS FOR TUNING A HOT MELT LIQUID DISPENSING SYSTEM CLOSED-LOOP CONTROLLER

(71) Applicant: Nordson Corporation, Westlake, OH (US)

(72) Inventor: Peter W. ESTELLE, Duluth, GA (US)

(21) Appl. No.: 17/760,917

(22) PCT Filed: Sep. 16, 2020
(86) PCT No.: PCT/US2020/050938

§ 371 Date: Mar. 16, 2022

Related U.S. Application Data
(60) Provisional application No. 62/901,119, filed on Sep. 16, 2019.

(51) Int. Cl. B05C 11/10; G05B 11/42; G05B 13/02; G05D 23/19

(52) U.S. Cl. CPC B05C 11/1042; G05B 11/42; G05B 13/024; G05D 23/1919

(57) ABSTRACT

Systems and methods for tuning a closed-loop controller for a hot melt liquid dispensing system are disclosed. In an example method, based on a set temperature setpoint, the hot melt liquid dispensing system is maintained at a steady state with respect to a temperature process variable and a heater duty cycle control variable. The heater duty cycle control variable is brought to a sustained oscillation. An amplitude and an ultimate period are determined. An ultimate gain is determining based on the step value and the amplitude. A proportional, integral, or derivative constant is determined based the ultimate period and/or ultimate gain. The closed-loop controller is implemented using the proportional, integral, or derivative constant.

### CROSS-REFERENCE TO RELATED APPLICATIONS

This application is a National Stage Application of International Patent Application No. PCT/US2020/050938, filed Sep. 16, 2020, which claims priority to U.S. Provisional Application No. 62/901,119 filed Sep. 16, 2019, the entire disclosures of both of which are hereby incorporated by reference as if set forth in their entirety herein.

### TECHNICAL FIELD

This disclosure generally relates to liquid dispensing and, more particularly, to tuning a hot melt liquid dispensing system closed-loop controller.

### BACKGROUND

Hot melt liquid dispensing systems find use in a variety of applications. For example, such a system may apply hot melt adhesives during the manufacture of disposable hygiene products. As another example, a hot melt liquid dispensing system may apply hot melt adhesive to assemble various types of packaging, such as paper-based packaging for food and beverages. Hot melt adhesives used in such applications may include moisture curing hot-melt polyurethane adhesives (“hot-melt PURs”), which are often used where a stable surface-to-surface bond must be formed. Other conventional hot melt adhesives may be used in securing a variety of both similar and dissimilar materials together in a mating relationship, such as wood, plastics, corrugated films, paper, carton stocks, metals, rigid polyvinylchlorides (PVCs), fabrics, leathers, and others. Hot melt adhesives may be especially useful in applications where it is desirable to have the adhesive solidify rapidly after being melted and dispensed.

In an example configuration of a hot melt liquid dispensing system, a solid form of hot melt adhesive is supplied to a melter comprising a heated tank and/or a heated grid to produce molten hot melt adhesive. After heating, the molten adhesive is pumped through a heated hose to an applicator, which is sometimes referred to as a dispensing “gun” or a gun module, comprising a valve and a nozzle. The applicator then dispenses the supplied molten adhesive to the desired surface or substrate, often as a series of dots or lines. It is most always crucial that the adhesive be applied with precise positioning, timing, and volume. For example, an insufficient volume of dispensed adhesive may result in ineffective bonds while an excessive volume of adhesive may result in not only wasted material but also undesirable flow once the adhesive is applied to a surface. In addition to parameters directly controlling an applicator, other process variables within the dispensing system also impact how effectively adhesive is applied to a surface. For instance, the volume and placement of dispensed adhesive may be affected by the viscosity of the melted adhesive, which, in turn, is a function of the temperature of the melted adhesive.

To regulate the various parameters of a hot melt adhesive dispensing system and achieve the desired adhesive application results, various control methodologies have been developed. One common mechanism for controlling a dispensing system is through use of a control loop system, such as a proportional-integral-derivative (PID) controller. Yet implementing an effective control loop system presents a number of challenges. For example, the values of constants used by a control loop system must be carefully set (e.g., tuned) to achieve optimal results. With respect to temperature, for instance, an untuned control loop may oscillate, thereby causing adhesive temperatures to vary in a manner similar to a sine wave. While these constants may be pre-set to default values, they are often sub-optimal under a specific installation of the dispensing system. For example, a dispensing system may be installed according to any one of numerous possible configurations, each including an equally large variety of equipment. Various types and quantities of hoses and guns may be potentially attached to a melter, for instance. Yet a melter (or other piece of equipment) may be sold by a manufacturer or supplier without advance knowledge of what other equipment will be used with the melter once the melter is put into service. Further, the initial equipment used with the melter may be reconfigured or swapped out for different equipment altogether. And even if it is possible to adjust the control loop constant values, this often requires specialized expertise and any trial and error attempts are very time consuming.

These and other shortcomings are addressed in the present disclosure.

### SUMMARY

Disclosed herein are system and methods for tuning a hot melt liquid dispensing system closed-loop controller. In an example method, the hot melt liquid dispensing system includes an applicator configured to dispense hot melt liquid and a hot melt liquid heater associated with the applicator. The closed-loop controller is configured to receive a hot melt liquid temperature setpoint and a measured hot melt liquid temperature process variable and output a duty cycle control variable for controlling the hot melt liquid heater. The method further comprises setting the temperature setpoint and, based on the temperature setpoint, maintaining the hot melt liquid dispensing system at a steady state with respect to the temperature process variable and the duty cycle control variable. The duty cycle control variable is alternately adjusted by positive and negative signs of a step value to cause sustained oscillation of the temperature process variable. An amplitude of the sustained oscillation and an ultimate period associated with the sustained oscillation are determined. An ultimate gain is determining based on the step value and the amplitude of the sustained oscillation. At least one of a proportional constant, an integral constant, or a derivative constant are determined based on at least one of the ultimate period or the ultimate gain. The closed-loop controller is implemented using the at least one of the proportional constant, the integral constant, or the derivative constant.

An example hot melt liquid dispensing system comprises an applicator, a hot melt liquid heater associated with the applicator, and a control system configured to implement a closed-loop controller. The closed-loop controller is configured to receive a hot melt liquid temperature setpoint and a measured hot melt liquid temperature process variable and output a duty cycle control variable for controlling the hot melt liquid heater. The control system is further configured to set the temperature setpoint. Based on the temperature setpoint, the hot melt liquid dispensing system is maintained at a steady state with respect to the temperature process variable and the duty cycle control variable. The duty cycle control variable is alternately adjusted by positive and negative signs of a step value to cause sustained oscillation of the temperature process variable. An amplitude of the sustained oscillation and an ultimate period associated with the sustained oscillation are determined. An ultimate gain is determining based on the step value and the amplitude of the sustained oscillation. At least one of a proportional constant, an integral constant, or a derivative constant are determined based on at least one of the ultimate period or the ultimate gain. The control system implements the closed-loop controller using the at least one of the proportional constant, the integral constant, or the derivative constant.

An example control system is provided for tuning a closed-loop controller for a hot melt liquid dispensing system having an applicator configured to dispense hot melt liquid and a hot melt liquid heater associated with the applicator. The closed-loop controller is configured to receive a hot melt liquid temperature setpoint and a measured hot melt liquid temperature process variable and output a duty cycle control variable for controlling the hot melt liquid heater. The control system comprises one or more processors and memory storing instructions that, when executed by the one or more processors, cause the control system to effectuate the following operations. A temperature setpoint is set, and, based on the temperature setpoint, the hot melt liquid dispensing system is maintained at a steady state with respect to the temperature process variable and the duty cycle control variable. The duty cycle control variable is alternately adjusted by positive and negative signs of a step value to cause sustained oscillation of the temperature process variable. An amplitude of the sustained oscillation and an ultimate period associated with the sustained oscillation are determined. An ultimate gain is determined based on the step value and the amplitude of the sustained oscillation. At least one of a proportional constant, an integral constant, or a derivative constant is determined based on at least one of the ultimate period or the ultimate gain. The closed-loop controller is implemented using the at least one of the proportional constant, the integral constant, or the derivative constant.

### BRIEF DESCRIPTION OF DRAWINGS

The accompanying drawings, which are incorporated in and constitute a part of this specification, illustrate embodiments and together with the description, serve to explain the principles of the methods and systems:

FIG. 1 illustrates an example dispensing system according to an embodiment of the present disclosure;

FIG. 2 illustrates an example schematic diagram according to an embodiment of the present disclosure;

FIG. 3 illustrates an example schematic diagram according to an embodiment of the present disclosure; and

FIG. 4 illustrates an example method flow chart according to an embodiment of the present disclosure.

Aspects of the disclosure will now be described in detail with reference to the drawings, wherein like reference numbers refer to like elements throughout, unless specified otherwise.

### DETAILED DESCRIPTION

The systems and methods of the present disclosure relate to tuning a hot melt liquid dispensing system closed-loop controller, such as a PID controller. The closed-loop controller may be implemented in a dispensing system for hot melt adhesives. Although reference shall be made primarily to hot melt adhesive, the techniques described herein may be applicable to any sort of hot melt liquid, including non-adhesives. Similarly, the techniques described herein are discussed typically with respect to tuning a hot melt liquid dispensing system closed-loop controller for temperature control loops. Yet such techniques are equally applicable for tuning a hot melt liquid dispensing system closed-loop controller for pressure control loops, flow control loops, foam density control loops, and control loops for other process variables of a hot melt liquid dispensing system. The closed-loop controller may comprise a PID controller. As such, tuning the PID controller may comprise determining the proportional (P), integral (I), and derivative (D) terms of the controller, as well as their respective constants (e.g., gains, integral time, or derivative time). The techniques described herein may be also applied to tuning a P, PI, or PD controller.

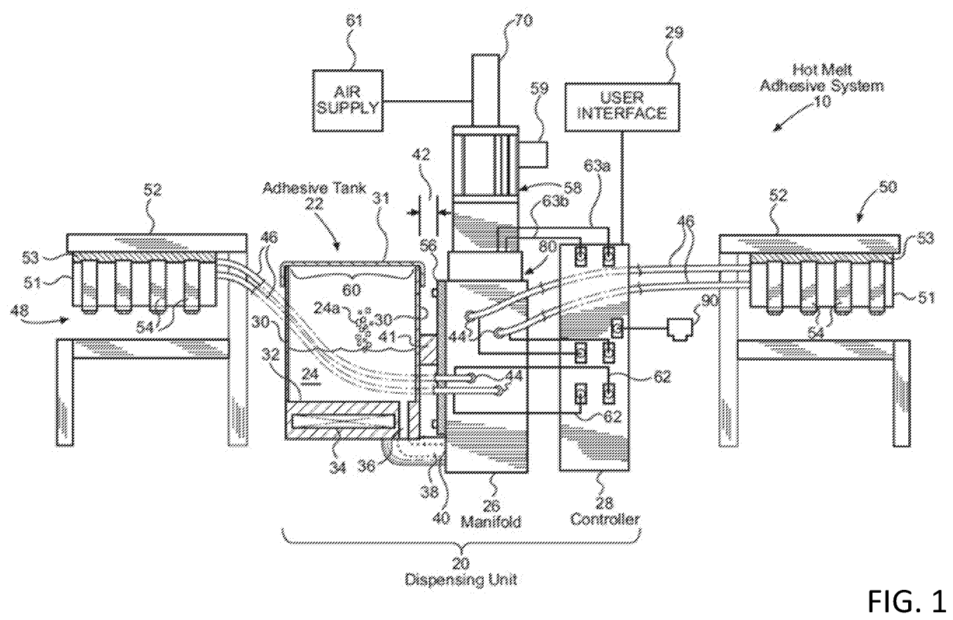

FIG. 1 illustrates an example hot melt adhesive system 10 (e.g., a hot melt adhesive dispensing system or other type of hot melt liquid dispensing system) with which the techniques described herein may be implemented. The hot melt adhesive system 10 comprises a dispensing unit 20 that includes an adhesive supply 22 for receiving and melting solid or semi-solid hot melt adhesive 24a, such as pellets, a manifold 26 connected to the adhesive supply 22, a controller 28, and a user interface 29. The adhesive supply 22 may be a tank-style melter, or a grid and reservoir melter, among others. Upon melting, the solid or semi-solid hot melt adhesive 24a stored in the adhesive supply 22 transforms into a liquid hot melt adhesive 24. The adhesive supply 22 comprises side walls 30, a removable cover 31, and a base 32 which includes one or more adhesive supply heaters 34 for melting and heating the hot melt adhesive 24a and the liquid hot melt adhesive 24 in the adhesive supply 22. An adhesive supply outlet 36 proximate the base 32 is coupled to a passage 38 which connects to an inlet 40 of the manifold 26.

A pump 58, such as a vertically-oriented piston pump (as shown) or a gear pump, is coupled to the manifold 26 for pumping liquid hot melt adhesive 24 from the adhesive supply 22 into the manifold 26, where it is split into separate flows. A pump motor 59 drives the pump 58. By operation of the pump 58 (and thus also as a function of the pump motor 59), the hot melt adhesive is supplied to the manifold 26 and applicators 48, 50 under pressure. Such pressure may affect the volume of hot melt adhesive that is dispensed in one applicator cycle (also referred to as a gun cycle) of an adhesive dispensing module 54, as well as generally the flow volume and flow rate of hot melt adhesive into, through, and/or out of the manifold 26.

The manifold 26 is mounted to a side wall 30 of the adhesive supply 22 with a spacer 41 and is spaced from the adhesive supply 22 a distance 42 sufficient to provide thermal isolation of the adhesive supply 22 from the manifold 26. The manifold 26 includes a plurality of outlet ports 44 which may be fitted with heated hoses 46 attached to one or more adhesive applicators 48, 50 to supply the liquid adhesive 24 to the applicators 48, 50. The manifold 26 may include a manifold heater 56 which is separate from the adhesive supply heater 34 and which can be independently controlled by the controller 28. In some embodiments, a single heater can be used for heating the adhesive supply 22 and the manifold 26. While FIG. 1 shows the adhesive supply 22 in close physical proximity to the manifold 26, other arrangements are also possible where the source of hot melt adhesive is physically distant from the manifold. In such arrangements, more than one pump may be used to move hot melt adhesive from the adhesive supply 22 toward the ultimate point of application.

The manifold 26 may create a plurality of flow streams that are carried by the corresponding heated hoses 46 to the applicators 48, 50. The hoses 46 are electrically coupled to the controller 28 by cord sets 62 associated with each hose 46. The applicators 48, 50 include one or more adhesive dispensing modules 54 configured to dispense/apply the liquid hot melt adhesive 24 to a product, such as a carton, package, or other object. The adhesive dispensing modules 54 are mounted to applicator bodies 51 having applicator heaters 53 and are supported on a frame 52. The hot melt adhesive system 10 includes two applicators 48, 50, with one applicator located on each side of the dispensing unit 20 as shown in FIG. 1, although other implementations of the hot melt adhesive system 10 may use a different number of applicators, dispensing modules, and other configurations. For example, the applicators 48, 50 may be each configured with a single adhesive dispensing module 54 or may be each configured with a pair of adhesive dispensing modules 54. The adhesive dispensing modules 54 of an applicator 48, 50 may be commonly monitored, controlled, and actuated by a common air supply. Alternatively, the adhesive dispensing modules 54 of an applicator 48, 50 may be independently monitored, controlled, and actuated by separate air supplies. An applicator 48, 50 and/or an adhesive dispensing module 54 may be variously referred to as an applicator or dispenser.

The pump 58 is located external to the adhesive supply 22 and is connected to an air pressure regulator 70 that receives air from an air supply 61. Where the pump 58 comprises a gear pump, the pump 58 may typically operate without air from any air supply 61. More particularly, the air pressure regulator 70 is mounted to the dispensing unit 20 and connects to the air supply 61. In some implementations, the pump 58 may be attached to the manifold 26 and heated by the manifold heater 56. This arrangement permits a larger tank opening 60, increases the tank capacity, and reduces the time required to heat the pump 58. Further, a flow meter 80 may be attached to the manifold 26 to measure hot melt adhesive flow therethrough. The flow meter 80 comprises a pair of sensors that are electrically coupled to the controller 28 by respective cords 63a, 63b associated with each sensor. At least one product detector 90, such as a photo-sensor, is also electrically coupled to the controller 28.

The dispensing unit 20 includes the controller 28 which may implement the PID controller (or other type of closed-loop controller) and associated tuning techniques described herein. The controller 28 houses the power supply and electronic controls for the hot melt adhesive system 10. The controller 28 may be configured with one or more processors and memory configured to store instructions that, when executed by the one or more processors, cause the controller 28 to effectuate various operations described herein, including the PID controller and associated tuning techniques. The controller 28 may be configured to monitor and store various measured process variables of the hot melt adhesive system 10, such as hot melt adhesive temperature, hot melt adhesive pressure, hot melt adhesive density (e.g., foam density), and hot melt adhesive flow (e.g., flow rate). The controller 28 may be configured to set, adjust, and store various input operating parameters (e.g., setpoints) of the hot melt adhesive system 10, such as a heater duty cycle, a hot melt adhesive temperature setpoint, a pressure of air supplied to the pump 58, and pump 58 speed.

With respect to the heating features of the hot melt adhesive system 10, the controller 28 is electrically coupled to the heaters, including the adhesive supply heater 34, the manifold heater 56, and the applicator heaters 53, as well as any hose heaters. The controller 28 may also be coupled with various temperature sensors in the hot melt adhesive system 10, which may be associated with or included in the adhesive supply heater 34, the manifold heater 56, the applicator heaters 53, and any hose heaters. The controller 28 independently monitors and adjusts the adhesive supply heater 34, the manifold heater 56, the applicator heaters 53, and any hose heaters, to melt solid or semi-solid hot melt adhesive 24a received in the adhesive supply 22 and to maintain the temperature of (melted) hot melt adhesive 24 to ensure proper viscosity of the hot melt adhesive 24 supplied to the applicators 48, 50 and dispensed by the adhesive dispensing modules 54. For instance, the controller 28 receives temperature information from temperature sensors (a measured temperature process value) and sends heater control instructions (e.g., a duty cycle control signal or control variable) to each heater to adjust the temperature to a temperature value set point. Such heater control instructions may increase or decrease the temperature of any or all of the heaters in the hot melt adhesive system 10.

Further to the above, the controller 28 may thus monitor, store, and set the various operating parameter values associated with a temperature of the hot melt adhesive within the hot melt adhesive system 10. In addition to the current and setpoint temperature values for the adhesive supply heater 34, the manifold heater 56, the applicator heaters 53, and hoses 46, the controller 28 may also monitor, store, and set duty cycle control information for any or all of the noted heaters. For example, the controller 28 may monitor, store, and set duty cycle control information for the adhesive supply heater 34. The duty cycle of a heater may refer to a percentage or ratio of time that the heater is activated (i.e., heating the associated hot melt adhesive) within an interval of time (i.e., the control period).

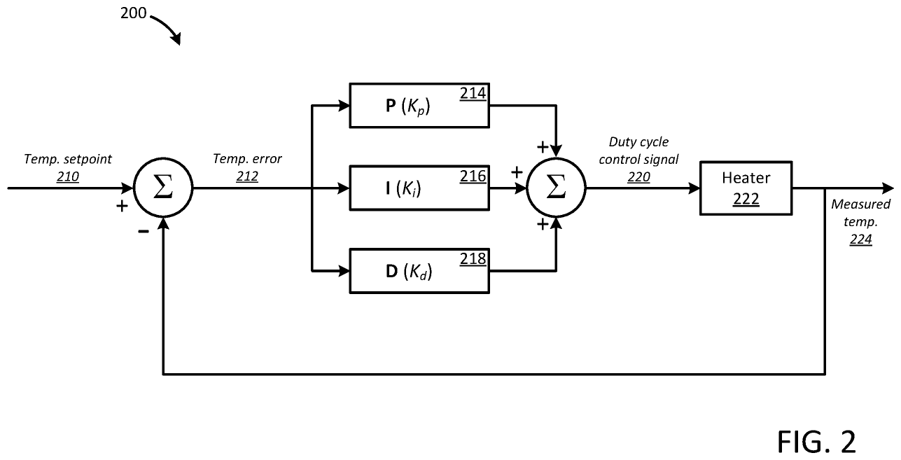

FIG. 2 illustrates a schematic diagram 200 comprising a PID controller associated with closed-loop temperature control of hot melt adhesive within a hot melt adhesive dispensing system (e.g., the hot melt adhesive system 10 of FIG. 1). The PID controller may be implemented by a controller of the hot melt adhesive dispensing system (e.g., the controller 28 of FIG. 1). The PID controller may be implemented in software associated with the controller, hardware associated with the controller, or a combination thereof. The controller may be configured to receive a temperature set point according to which the hot melt adhesive within the system is to be maintained, as well as a current measured temperature of the hot melt adhesive. In particular, the temperature set point may be the temperature at which the hot melt adhesive is to be dispensed from the applicator(s) of the system. The controller may be further configured to determine and generate a duty cycle control signal to one or more heaters (e.g., the adhesive supply heater 34, the manifold heater 56, the applicator heaters 53, and/or hose heaters of FIG. 1) of the system. The duty cycle control signal may indicate a duty cycle control variable (e.g., a duty cycle process variable or gain) according to which the heater(s) are to operate. It will be noted that FIG. 2 illustrates a system with a single channel. A system may often include a plurality of such channels. For example, a system may comprise a plurality of heaters. In this instance, the system may implement a plurality of PID controllers, each controlling a separate heater of the plurality of heaters. The same may be held with respect to other components and/or processes of the system.

Initially, the controller receives a temperature setpoint 210 for the hot melt adhesive within the system. The controller additionally receives, via a temperature sensor, a current or near-current measured temperature 224 of the hot melt adhesive. The temperature setpoint 210 may be considered the setpoint (SP) or function r(t) according to some common control loop nomenclatures. The measured temperature 224 may be considered the process variable (PV) or the function y(t) also according to some common control loop nomenclatures. The controller subsequently determines a difference between the temperature setpoint 210 and the measured temperature 224 to determine a temperature error 212. The temperature error 212 may be considered the error function e(t) according to some common control loop nomenclatures. The controller applies one or more of a proportional (P) term 214, an integral (I) term 216, and a derivative (D) term 218 to the temperature error 212 to determine a corrective duty cycle control signal 220 for the heater(s) of the system. The duty cycle control signal 220 may be considered the function u(t) according to some common control loop nomenclatures. In a strict PID controller, each of the proportional term 214, integral term 216, and derivative term 218 are applied to the temperature error 212. In a PI controller, only the proportional term 214 and integral term 216 are applied to the temperature error 212. In a PD controller, only the proportional term 214 and derivative term 218 are applied to the temperature error 212. In a P controller, only the proportional term 214 is applied to the temperature error 212.

The proportional term 214 may be applied to the temperature error 212 according to a proportional constant. The proportional constant may comprise a proportional gain Kₚ in the parallel (ideal) form of the PID controller. It is noted that the descriptions and equations provided herein relate primarily to the parallel form of the PID controller. The same or similar techniques or principles may be implemented in other forms, such as standard form, with slightly different equations. The proportional term 214 may be determined according to Eq. (1) below.

P=Kₚe(t) Eq. (1):

The integral term 216 may be additionally or alternatively applied to the temperature error 212 according to an integral constant. In the parallel form of the PID controller, the integral constant comprises an integral gain Kᵢ (shown in FIG. 2). The integral term 216 may be determined according to Eq. (2) below.

$$I = {K}_{i} {\int }_{0}^{t} e ( r ) d r \qquad Eq . ( 2 )$$

The derivative term 218 may be additionally or alternatively applied to the temperature error 212 according to a derivative constant. In the parallel form, the derivative constant comprises a derivative gain K_{d}. The derivative term 218 may be determined according to Eq. (3) below.

$$D = {K}_{d} \frac{de ( t )}{dt} \qquad Eq . ( 3 )$$

In the parallel form of the PID controller, the proportional term 214, the integral term 216, and the derivative term 218 may be applied to the temperature error 212 according to Eq. (4) below to determine the duty cycle control signal 220 (i.e., u(t)).

$$u ( t ) = {K}_{p} e ( t ) + {K}_{i} {\int }_{0}^{t} e ( r ) d r + {K}_{d} \frac{d}{dt} e ( t ) \qquad Eq . ( 4 )$$

In other words, the duty cycle control signal 220 (i.e., u(t)) may equal the proportional term 214 plus the integral term 216 and plus the derivative term 218.

In the standard form of the PID controller, the proportional term 214, the integral term 216, and the derivative term 218 may be applied to the temperature error 212 according to Eq. (5) below to determine the duty cycle control signal 220 (i.e., u(t)).

$$u ( t ) = {K}_{p} ( e ( t ) + \frac{1}{{T}_{i}} {\int }_{0}^{t} e ( r ) d r + {T}_{d} \frac{d}{dt} e ( t ) ) \qquad Eq . ( 5 )$$

In Eq. (5), Tᵢ refers to an integral time, Kₚ refers to a proportional gain, and T_{d} refers to a derivative time. In the standard form and according to some nomenclatures, Kₚ may be instead referred to as K_{c}. The standard form and the parallel form are related in that Kᵢ=Kₚ/Tᵢ and K_{d}=KₚT_{d}. Or in some instances, Kᵢ=1/Tᵢ and K_{d}=T_{d}.

The heater 222 (or a plurality of heaters, as the case may be) operates according to the generated duty cycle control signal 220. In some instances, another component or process of the system may operate according to a control signal that is analogous to the duty cycle control signal 220. The duty cycle control signal 220 may cause the heater 222 to increase its duty cycle, decrease its duty cycle, or maintain its present duty cycle. Thus, the temperature of the hot melt adhesive may be raised, lowered, or maintained accordingly. The new measured temperature 224 reflects the operation of the heater 222 based on the duty cycle control signal 220. Since there is often a certain period of lag time between when a heater's duty cycle is adjusted and when a resultant change in temperature occurs, the measured temperature 224 may be captured after a pre-specified period of time has elapsed since the duty cycle was adjusted by the duty cycle control signal 220. It is further noted that, following a heater duty cycle adjustment, a temperature change may occur gradually until reaching a temperature that ultimately reflects the duty cycle adjustment indicated by the duty cycle control signal 220. A further iteration of the control loop may be performed using the new measured temperature 224, and so forth, to effectuate temperature control for the hot melt adhesive dispensing system. For example, the control loop may run continuously, repeating each control period or interval.

The controller may be also applied to other process variables or aspects of the hot melt adhesive dispensing system. For example, the controller may be applied to the pressure at which hot melt adhesive is supplied to an applicator. In this example pressure control loop, a pressure setpoint may comprise the setpoint (SP) or r(t) of the controller and a measured pressure may comprise the process variable (PV) or y(t) of the controller. A control signal to the pump (and/or pump motor) of the hot melt adhesive dispensing system may comprise the manipulated variable (MV) or u(t) of the controller. For instance, the control signal to the pump may adjust the speed (e.g., revolutions or cycles per minute) of the pump. As another example, the controller may be applied to the flow rate at which the hot melt adhesive is supplied to the applicator. In this example flow control loop, a flow rate setpoint may comprise the setpoint (SP) or r(t) and a measured flow rate may comprise the process variable (PV) or y(t). A control signal to the pump (and/or pump motor) may comprise the manipulated variable (MV) or u(t), such as to adjust the speed of the pump. As another example, the controller may be applied to a foam density of the hot melt adhesive supplied to the applicator. Foam density may refer to the relationship between the liquid hot melt (with respect to mass or volume) and gas in the foam. Foam density may be measured and/or adjusted in several ways. For example, the foam density may be lowered by mixing more gas in to the liquid stream.

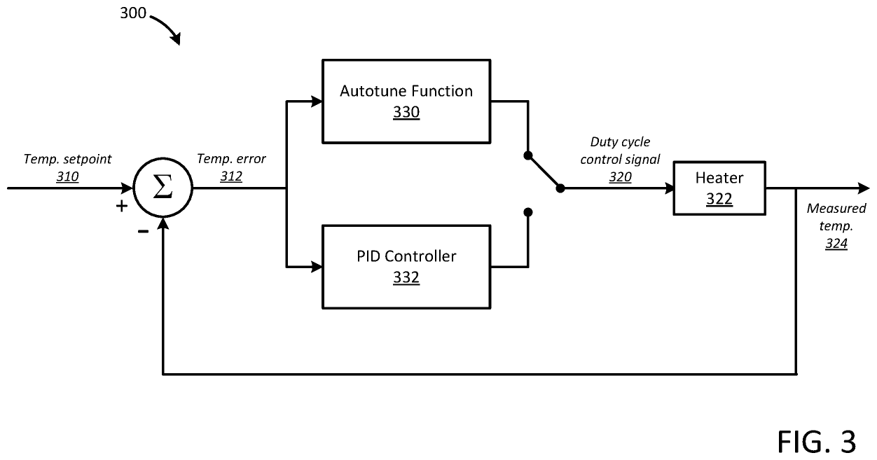

FIG. 3 illustrates a schematic diagram 300 of a control system comprising an autotune function 330 and a PID controller 332 (or other closed-loop controller, including a P controller, PI controller, or PD controller). The control system may be generally used to autotune the PID controller 332. The control system may be switched between an operational mode (using the PID controller 332) and an autotune mode (using the autotune function 330). An operator may selectively cause the control system to switch between the operational mode and the autotune mode. Additionally or alternatively, the control system may automatically switch between the operational mode and the autotune mode upon determining that the hot melt adhesive dispensing system is operating outside of required tolerances (e.g., with respect to dispensed volume, placement, timing, etc.). The autotune mode may be activated while the hot melt adhesive dispensing system applies hot melt adhesive to actual product (i.e., online) or, preferably, while the hot melt adhesive dispensing system is not dispensing hot melt adhesive to actual product (i.e., offline). In the operational mode, the hot melt adhesive dispensing system applies hot melt adhesive to actual product in accordance with, preferably, the required tolerances.

In the operational mode, the control process generally proceeds in the manner described in relation to FIG. 2. As such, a hot melt adhesive temperature setpoint 310 is input and compared with a measured [hot melt adhesive] temperature 324 to determine a temperature error 312. The temperature setpoint 310 may be input by an operator, for example. The temperature error 312 is input to the PID controller 332. The PID controller 332 may be the same as or similar to the PID controller described in relation to FIG. 2. The PID controller 332 may comprise one or more of a proportional term, an integral term, and a derivative term (e.g., the proportional term 214, integral term 216, and derivative term 218 of FIG. 2, respectively) and respective constants (e.g., gains, integral time, and/or derivative time). Based on the temperature error 312 and the PID controller's 332 proportional, integral, and/or derivative terms (and respective constants), the PID controller 332 determines a duty cycle control signal 320 for operation of the hot melt adhesive heater(s) 322 (or other component or process of the system). A new measured temperature 324 is taken and further iterations of the control process may be performed in a similar manner to effectuate temperature control.

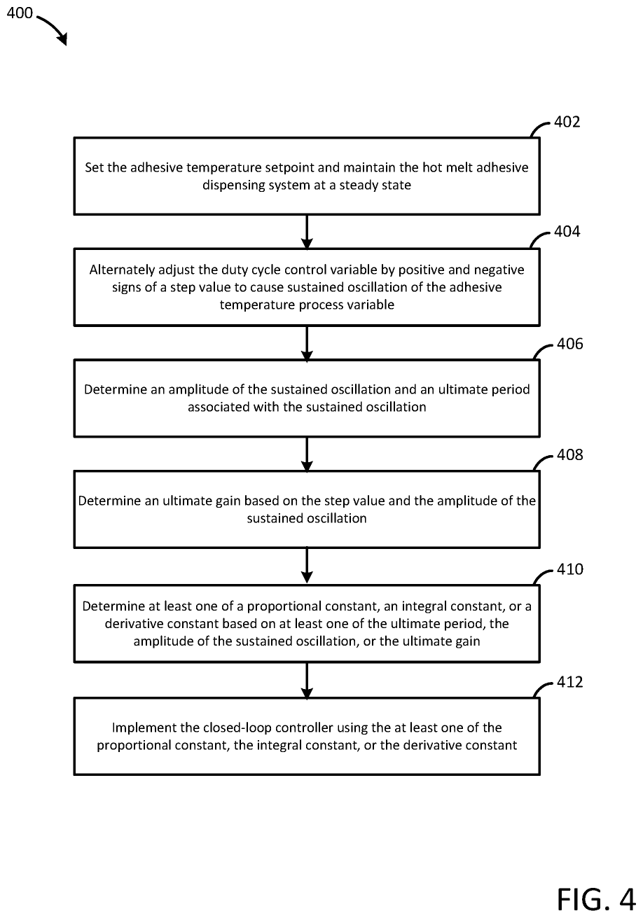

In the autotune mode, a temperature setpoint 310 is similarly input and compared to a measured temperature 324 to determine a temperature error 312. The temperature setpoint 310 may be input by an operator, for example. The temperature error 312 is input to the autotune function 330. The autotune function 330 may comprise a relay autotune function and thus introduce a relay to the feedback control loop of the control system. Generally, the autotune function 330 extracts the step value and frequency (i.e., period) near the critical point (i.e., point of oscillation). The autotune function 330 uses the determined step value and frequency to determine one or more of the proportional, integral, and derivatives terms' respective constants (e.g., Kₚ, Kᵢ, and K_{d} in parallel form) for the PID controller 332. More particularly, the step value (with respect to the duty cycle control signal 320) is selected to achieve (e.g., incrementally increased) sustained oscillation (with respect to the measured temperature 324). The ultimate period and amplitude of the sustained oscillation are determined. The ultimate gain is, in turn, determined based on the amplitude of the oscillation. The proportional, integral, and derivatives terms' respective constants are determined based on one or more of the ultimate period and ultimate gain. The autotuning process will be described in further detail in relation to the data flow diagram of FIG. 4. In the operational mode, the PID controller 332 applies such constants to implement temperature control of the hot melt adhesive dispensing system.

FIG. 4 illustrates a data flow diagram of a method 400 for tuning (e.g., autotuning) a closed-loop controller for a hot melt adhesive dispensing system (e.g., the hot melt adhesive system 10 of FIG. 1). The closed-loop controller may comprise a PID controller, a P controller, a PI controller, or a PD controller (e.g. the PID controller discussed in relation to FIG. 2 or the PID controller 332 of FIG. 3). The closed-loop controller may be implemented by the controller 28 of FIG. 1. The hot melt adhesive dispensing system may comprise an applicator configured to dispense hot melt adhesive and a hot melt adhesive heater associated with the applicator. The applicator may be realized according to one or more of the applicator 48, 50 and the adhesive dispensing module 54 of FIG. 1. The hot melt adhesive heater may be realized according to one or more of the adhesive supply heater 34, the manifold heater 56, the applicator heaters 53, and the hose heaters of FIG. 1.

The closed-loop controller may be configured to receive an adhesive temperature setpoint (e.g., the temperature setpoint 210, 310 of FIGS. 2 and 3, respectively) and a measured adhesive temperature process variable (e.g., the measured temperature 224, 324 of FIGS. 2 and 3, respectively). The closed-loop controller may be further configured to output a duty cycle control variable (e.g., the duty cycle control signal 220, 320 of FIGS. 2 and 3, respectively) for controlling the hot melt adhesive heater. Although the method 400 is described with respect to hot melt adhesive and a hot melt adhesive dispensing system, the techniques described herein apply equally to other types of hot melt liquid and hot melt liquid dispensing systems.

The method 400 may be initiated by an operator. Additionally or alternatively, the method 400 may be initiated by the hot melt adhesive dispensing system or the closed-loop controller. For example, the hot melt adhesive dispensing system may determine that hot melt adhesive is being applied outside of acceptable tolerances (e.g., with respect to dispensed volume, placement, timing, etc.). Initiating the method may comprise switching the hot melt adhesive dispensing system from an operational mode (see discussion relating to the PID controller 332 in FIG. 3) to an autotune mode (see discussion relating to the autotune function 330 of FIG. 3).

At step 402, the adhesive temperature setpoint is set and the hot melt adhesive dispensing system is brought to and maintained at a steady state. The steady state may be with respect to the temperature of the hot melt adhesive (e.g., the measured adhesive temperature process variable) and the duty cycle process control variable. In the steady state, the measured adhesive temperature process variable may swing (e.g., oscillate) about the adhesive temperature setpoint. Such swing or oscillation may be due to the un-tuned state of the closed-loop controller. An average of the duty cycle control variable over a period of time (e.g., a pre-determined period of time) in the steady state may be determined. The closed-loop controller may be tuned based on the average of the duty cycle control variable for the adhesive temperature setpoint. Further, an average of the measured adhesive temperature process variable over the period of time in the steady state may be determined. The period of time may be measured from the time that the measured adhesive temperature process variable reaches the adhesive temperature setpoint. The period of time may be determined so as to minimize offsets due to incomplete swings of the measured adhesive temperature process variable above and below the adhesive temperature setpoint. Rather than a period of time, the averages of the duty cycle control variable and/or measured adhesive temperature process variable may be determined over a certain number (e.g., a pre-defined number) of datapoints (e.g., 200 datapoints). In some instances, an initial wait time may be beneficial before beginning to determine the averages of the duty cycle control variable and/or measured adhesive temperature process variable. For example, the method 400 may have commenced while the hot melt adhesive dispensing system was cold or well below the adhesive temperature setpoint. In this case, an initial warmup period may be beneficial. The initial wait time or warmup period may end when the measured adhesive temperature process variable reaches the adhesive temperature setpoint.

At step 404, the duty cycle control variable is alternately adjusted by positive and negative signs of a step value to cause a sustained oscillation of the adhesive temperature process variable. The duty cycle control variable may be alternately adjusted based on the determined average of the duty cycle control variable. Additionally or alternatively, the duty cycle control variable may be alternately adjusted based on the determined average of the measured adhesive temperature process variable. The duty cycle control variable that is initially adjusted may be the determined average of the duty cycle control variable. The step value may comprise an amplitude of the driving function that causes the oscillation of the adhesive temperature process variable. The oscillation may be sustained for a pre-determined period of time. The step value may be determined based on a current duty cycle control variable (e.g., the current duty cycle setpoint). For example, based on the current duty cycle control variable, the step value may be determined such that adjusting the current duty cycle control variable by positive or negative signs of the step value do not cause the duty cycle control variable to fall below 0% or above 100%. Causing the sustained oscillation of the adhesive temperature process variable may comprise adjusting the duty cycle control variable by a positive sign of the step value. Responsive to determining that the adhesive temperature process variable is above the adhesive temperature setpoint (e.g., crosses the adhesive temperature setpoint from below or at the adhesive temperature setpoint to above the adhesive temperature setpoint), the duty cycle control variable is adjusted by a negative sign of the step value. Responsive to determining that the adhesive temperature process variable is below the adhesive temperature setpoint (e.g., crosses the adhesive temperature setpoint from above or at the adhesive temperature setpoint to below the adhesive temperature setpoint), the duty cycle control variable is adjusted by the positive sign of the step value. Further similar iterations of alternately adjusting the duty cycle control variable by positive and negative signs of the step value are performed until the oscillation is sustained, such as for the pre-determined period of time.

In an aspect, hysteresis may be applied to the adhesive temperature setpoint when generating the sustained oscillation of the adhesive temperature process variable. For example, a crossover threshold range may be used instead of the single adhesive temperature setpoint. The crossover threshold range may comprise a lower adhesive temperature threshold value and an upper adhesive temperature threshold value. When generating the sustained oscillation and after adjusting the duty cycle control variable by a positive sign of the step value, the duty cycle control variable may be re-adjusted by the negative sign of the step value only when the adhesive temperature process variable crosses (i.e., rises above) the upper adhesive temperature threshold value. Conversely, after the duty cycle control variable is adjusted by the negative sign of the step value, the duty cycle control variable may be re-adjusted by the positive sign of the step value only after the temperature adhesive process variable crosses (i.e., falls below) the lower adhesive temperature threshold value. Small amounts of hysteresis may help improve the reliability of the autotuning process in the presence of A/D converter quantization or environmental electrical noise, for example.

At step 406, an amplitude of the sustained oscillation and an ultimate period associated with the sustained oscillation are determined. The ultimate period may be referred to as Pᵤ according to some nomenclatures. The ultimate period may be determined based on the observed period (P) of the sustained oscillation such that the ultimate period (Pᵤ) equals the period (P). The amplitude of the sustained oscillation may be referred to as the amplitude A. At step 408, an ultimate gain Kᵤ is determined based on the step value and the amplitude of the sustained oscillation. The ultimate gain Kᵤ may be determined according to Eq. (6) below, wherein the step value is indicated as d and the amplitude of the sustained oscillation is indicated as A.

$${K}_{u} = \frac{( 4 \times d )}{( π \times A )} \qquad Eq . ( 6 )$$

In an aspect, the amplitude A and the ultimate period Pᵤ may be determined based on a sample subset of oscillations (e.g., cycles) of the sustained oscillations. The ultimate period Pᵤ may be determined based on the average observed period (P) of the sample subset of oscillations. The amplitude A may be determined based on an average amplitude of the sample subset of oscillations.

At step 410, at least one of a proportional constant, an integral constant, or a derivative constant are determined based on at least one of the ultimate period or the ultimate gain. For a PID controller, the proportional constant, the integral constant, and the derivative constant are each determined. The proportional constant may be determined based on at least the ultimate gain. The integral constant and the derivative constant may be determined based on at least the ultimate period. The proportional constant, the integral constant, and/or the derivative constant may be determined based, for example, on the Ziegler-Nichols rules applied to the ultimate gain and the ultimate period. Other rules or methodologies may be used to determine the proportional constant, the integral constant, and/or the derivative constant based on at least one of the ultimate period or the ultimate gain. The proportional constant (e.g., the proportional gain) may be determined according to Eq. (7) below in which Kₚ indicates the proportional gain and Kᵤ indicates the ultimate gain.

Kₚ=0.6×Kᵤ Eq. (7):

The integral constant comprises the integral gain Kᵢ. The integral gain Kᵢ may be determined according to Eq. (8) below in which Tᵢ refers to the integral time.

$${K}_{i} = \frac{2}{{P}_{u}} \qquad Eq . ( 8 )$$

In the standard form of the PID controller, the derivative constant comprises the derivative time T_{d}. In the parallel form of the PID controller, the derivative constant comprises the derivative gain K_{d}, which may be determined according to Eq. (9) below. The derivative gain K_{d} may equal the derivative time T_{d} used in the standard form.

$${K}_{d} = \frac{{P}_{u}}{8} \qquad Eq . ( 9 )$$

At step 412, the closed-loop controller is implemented using at least one of the proportional constant, the integral constant, or the derivative constant. That is, the proportional constant is applied to the proportional term, the integral constant is applied to the integral term, and/or the derivative constant is applied to the derivative term. In the case in which the closed-loop controller is a PID controller, the PID controller is implemented using each of the proportional constant, the integral constant, and the derivative constant. In a parallel form of the PID controller, the proportional constant comprises the proportional gain Kₚ, the integral constant comprises the integral gain Kᵢ, and the derivative constant comprises the derivative gain K_{d}. In the parallel form, the PID controller may be implemented according to Eq. (4).

After the closed-loop controller (e.g., the PID controller) is implemented in step 412, the hot melt adhesive dispensing system may be switched to the operational mode. In the operational mode, the hot melt adhesive heater heats the hot melt adhesive according to the duty cycle control variable which, in turn, is controlled via the implemented (tuned) closed-loop controller using at least one of the proportional constant, the integral constant, or the derivative constant.

After the closed-loop controller is tuned, the quality of the tuning may be assessed. In one example, a tuning quality indicator may be determined based on the measured adhesive temperature process variable. Determining the value of the tuning quality indicator may be based on the difference between the mean of the measured adhesive temperature process variable and the adhesive temperature setpoint, as well as the variation or standard deviation in the measured adhesive temperature process variable. Optimal tuning may have occurred when the mean of the measured adhesive temperature process variable is centered on the adhesive temperature setpoint and the values of the measured adhesive temperature process variable are all near the adhesive temperature setpoint. Other methods of assessing the quality of the tuning are also contemplated.

As noted above, rather than hot melt adhesive temperature, the method 400 may be performed with respect to the pressure of the hot melt adhesive supplied to the applicator, the flow rate of the hot melt adhesive supplied to the application and/or manifold, or the foam density as it is supplied to the applicator.

The control system and controller (e.g., PID controller) tuning techniques described herein realize numerous benefits when applied to a hot melt adhesive dispensing system or other type of hot melt liquid dispensing system. For example, the closed-loop control techniques described herein avoid many of the drawbacks associated with un-optimized feedback control loops or even open-loop control systems, such as causing the process to move away from a setpoint over feedback loops, either slowly (“drift”) or quickly (“run away”). As another example, the tuning techniques described herein may be implemented even while the associated hot melt adhesive dispensing system is operating. As another example, the control system and tuning techniques described herein are particularly suitable for hot melt liquid dispensing systems, which often experience relatively long time constants or dead times due to the time delay between when a duty cycle control variable is adjusted and when the corresponding change in adhesive temperature is observed. As yet another example, the techniques described herein may be used to quickly and easily re-tune a controller (e.g., PID controller) after one or more parts or components of the hot melt adhesive dispensing system are replaced, altered, or swapped or if various other operating parameters of the hot melt adhesive dispensing system are changed.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method for tuning a closed-loop controller for a hot melt liquid dispensing system having an applicator configured to dispense hot melt liquid and a hot melt liquid heater associated with the applicator, the closed-loop controller configured to receive a hot melt liquid temperature setpoint and a measured hot melt liquid temperature process variable and output a duty cycle control variable for controlling the hot melt liquid heater, the method comprising:
setting the hot melt liquid temperature setpoint;
based on the hot melt liquid temperature setpoint, maintaining the hot melt liquid dispensing system at a steady state with respect to the measured hot melt liquid temperature process variable and the duty cycle control variable;
alternately adjusting the duty cycle control variable by positive and negative signs of a step value to cause sustained oscillation of the measured hot melt liquid temperature process variable;
determining an amplitude of the sustained oscillation and an ultimate period associated with the sustained oscillation;
determining an ultimate gain based on the step value and the amplitude of the sustained oscillation;
determining at least one of a proportional constant, an integral constant, or a derivative constant based on at least one of the ultimate period or the ultimate gain; and
implementing the closed-loop controller using the at least one of the proportional constant, the integral constant, or the derivative constant.

2. The method of claim 1, wherein causing the sustained oscillation of the measured hot melt liquid temperature process variable comprises:
adjusting the duty cycle control variable by a positive sign of the step value;
responsive to determining that the measured hot melt liquid temperature process variable is above the hot melt liquid temperature setpoint, adjusting the duty cycle control variable by a negative sign of the step value;
responsive to determining that the measured hot melt liquid temperature process variable is below the hot melt liquid temperature setpoint, adjusting the duty cycle control variable by the positive sign of the step value; and
alternately adjusting the duty cycle control variable by positive and negative signs of the step value until the oscillation is sustained.

3. The method of claim 2, wherein:
the hot melt liquid temperature setpoint comprises a temperature setpoint threshold range defined by a lower temperature threshold value and an upper temperature threshold value,
the duty cycle control variable is adjusted by the negative sign of the step value responsive to determining that the measured hot melt liquid temperature process variable is above an upper temperature threshold value, and
the duty cycle control variable is adjusted by the positive sign of the step value responsive to determining that the measured hot melt liquid temperature process variable is below the lower temperature threshold value.

4. The method of claim 1, wherein the closed-loop controller comprises a PID controller and is implemented using the proportional constant, the integral constant, and the derivative constant.

5. The method of claim 1, wherein the ultimate gain is inversely proportional to the amplitude of the sustained oscillation.

6. The method of claim 1, wherein the proportional constant is based on and proportional to the ultimate gain.

7. The method of claim 1, wherein the closed-loop controller comprises a PID controller in parallel form, the proportional constant comprises a proportional gain, the integral constant comprises an integral gain, and the derivative constant comprises a derivative gain.

8. The method of claim 1, wherein the amplitude of the sustained oscillation and the ultimate period are determined based on a subset of cycles of the sustained oscillation.

9. The method of claim 8, wherein the amplitude of the sustained oscillation comprises an average amplitude of the subset of cycles and the ultimate period comprises an average period over the subset of cycles.

10. The method of claim 1, wherein the steady state of the hot melt liquid dispensing system is maintained over a period of time and the duty cycle control variable is alternately adjusted by positive and negative signs of the step value based on an average of the duty cycle control variable over the period of time.

11. The method of claim 10, wherein an initially adjusted duty cycle control variable comprises the average of the duty cycle control variable over the period of time.

12. A system, comprising:
an applicator configured to dispense hot melt liquid;
a hot melt liquid heater associated with the applicator; and
a control system configured to implement a closed-loop controller, the closed-loop controller being configured to receive a hot melt liquid temperature setpoint and a measured hot melt liquid temperature process variable and output a duty cycle control variable for controlling the hot melt liquid heater, and the control system being further configured to tune the closed-loop controller by:
setting the hot melt liquid temperature setpoint;
based on the hot melt liquid temperature setpoint, maintaining the system at a steady state with respect to the measured hot melt liquid temperature process variable and the duty cycle control variable;
alternately adjusting the duty cycle control variable by positive and negative signs of a step value to cause sustained oscillation of the measured hot melt liquid temperature process variable;
determining an amplitude of the sustained oscillation and an ultimate period associated with the sustained oscillation;
determining an ultimate gain based on the step value and the amplitude of the sustained oscillation;
determining at least one of a proportional constant, an integral constant, or a derivative constant based on at least one of the ultimate period or the ultimate gain; and
implementing the closed-loop controller using the at least one of the proportional constant, the integral constant, or the derivative constant.

13. The system of claim 12, wherein causing the sustained oscillation of the measured hot melt liquid temperature process variable comprises:
adjusting the duty cycle control variable by a positive sign of the step value;
responsive to determining that the measured hot melt liquid temperature process variable is above the hot melt liquid temperature setpoint, adjusting the duty cycle control variable by a negative sign of the step value;
responsive to determining that the measured hot melt liquid temperature process variable is below the hot melt liquid temperature setpoint, adjusting the duty cycle control variable by the positive sign of the step value; and
alternately adjusting the duty cycle control variable by positive and negative signs of the step value until the oscillation is sustained.

14. The system of claim 13, wherein:
the hot melt liquid temperature setpoint comprises a temperature setpoint threshold range defined by a lower temperature threshold value and an upper temperature threshold value,
the duty cycle control variable is adjusted by the negative sign of the step value responsive to determining that the measured hot melt liquid temperature process variable is above an upper temperature threshold value, and
the duty cycle control variable is adjusted by the positive sign of the step value responsive to determining that the measured hot melt liquid temperature process variable is below the lower temperature threshold value.

15. The system of claim 12, wherein the closed-loop controller comprises a PID controller and is implemented using the proportional constant, the integral constant, and the derivative constant.

16. The system of claim 12, wherein the amplitude of the sustained oscillation and the ultimate period are determined based on a subset of cycles of the sustained oscillation.

17. The system of claim 16, wherein the amplitude of the sustained oscillation comprises an average amplitude of the subset of cycles and the ultimate period comprises an average period over the subset of cycles.

18. The system of claim 12, wherein the steady state of the hot melt liquid dispensing system is maintained over a period of time and the duty cycle control variable is alternately adjusted by positive and negative signs of the step value based on an average of the duty cycle control variable over the period of time.

19. The system of claim 18, wherein an initially adjusted duty cycle control variable comprises the average of the duty cycle control variable over the period of time.

20. A control system for tuning a closed-loop controller for a hot melt liquid dispensing system having an applicator configured to dispense hot melt liquid and a hot melt liquid heater associated with the applicator, the closed-loop controller configured to receive a hot melt liquid temperature setpoint and a measured hot melt liquid temperature process variable and output a duty cycle control variable for controlling the hot melt liquid heater, the control system comprising:
one or more processors; and
memory storing instructions that, when executed by the one or more processors, cause the control system to:
set the hot melt liquid temperature setpoint;
based on the hot melt liquid temperature setpoint, maintain the hot melt liquid dispensing system at a steady state with respect to the measured hot melt liquid temperature process variable and the duty cycle control variable;
alternately adjust the duty cycle control variable by positive and negative signs of a step value to cause sustained oscillation of the measured hot melt liquid temperature process variable;
determine an amplitude of the sustained oscillation and an ultimate period associated with the sustained oscillation;
determine an ultimate gain based on the step value and the amplitude of the sustained oscillation;
determine at least one of a proportional constant, an integral constant, or a derivative constant based on at least one of the ultimate period or the ultimate gain; and
implement the closed-loop controller using the at least one of the proportional constant, the integral constant, or the derivative constant.
